(19) United States
(12) Patent Application Publication
(10) Pub. No.: US 2014/0278329 A1
(43) Pub. Date: Sep. 18, 2014

(54) Modeling Content-Addressable Memory For Emulation

(71) Applicant: MENTOR GRAPHICS CORPORATION, Wilsonville, OR (US)

(72) Inventors: Charles Selvidge, Wellesley, MA (US); Yuewei Liu, Paris (FR)

(73) Assignee: MENTOR GRAPHICS CORPORATION, Wilsonville, OR (US)

(21) Appl. No.: 13/840,517

(22) Filed: Mar. 15, 2013

(51) Int. Cl. G06F 17/50

(52) U.S. Cl. CPC G06F 17/5022
USPC 703/15; 703/14

(57) ABSTRACT

Aspects of the invention relate to techniques for modeling content-addressable memory for emulation. An emulation device according to various embodiments of the invention comprises one or more memory modeling blocks reconfigurable to emulate a content-addressable memory or a random-access memory. The emulation device may be processor-based or FPGA-based. Each of the one or more memory modeling blocks comprises memory circuitry and a dedicated comparison unit configured to compare a search word or a portion of a search word received by the each of the one or more memory modeling blocks with data stored in the memory circuitry. The comparison unit may comprise a comparator and a register coupled to the comparator and configured to store matching data. The matching data may be unencoded matching data. A plurality of the memory modeling blocks may be programmable to emulate a single content-addressable memory.

### FIELD OF THE INVENTION

The present invention relates to the field of circuit design verification technology. Various implementations of the invention may be particularly useful for modeling content-addressable memory for emulation.

### BACKGROUND OF THE INVENTION

Modern integrated circuit designs have become extremely complex. As a result, various techniques have been developed to verify that circuit designs will operate as desired before they are implemented in an expensive manufacturing process. For example, logic simulation is a tool used for verifying the logical correctness of a hardware design. Designing hardware today involves writing a program in the hardware description language. Performing a simulation is just running that program. If the program (or model) runs correctly, then one can be reasonably assured that the logic of the design is correct at least for the cases tested in the simulation.

Software-based simulation, however, may be too slow for large complex designs such as SoC (System on Chip) designs. Although design reuse, intellectual property, and high-performance tools all help by shortening SoC design time, they do not diminish the system verification bottleneck, which consumes 60-70% of the design cycle. Hardware emulation provides an effective way to increase verification productivity, speed up time-to-market, and deliver greater confidence in final products. In hardware emulation, a portion of a circuit design or the entire circuit design is emulated with an emulation circuit or “emulator.” Two categories of emulators have been developed. The first category is FPGA (field programmable gate array)-based: A design is first synthesized into a gate netlist, and FPGAs are mapped to the netlist and are programmed to the gate functionally. The FPGA-based emulators may use commercial FPGA chips or custom-designed FPGA chips. The second category is processor-based: an array of Boolean processors able to share data with one another is employed to map the design, and Boolean operations are scheduled and performed accordingly. Whether FPGA-based or processor-based, an emulator executes the emulation in parallel whereas a simulator executes the simulation in serial, leading to orders of magnitude differences in execution time.

An emulator usually comprises an array of emulation devices (FPGA-based or processor-based), each of the emulation chips modeling a part of a large circuit design. An emulation chip may comprise logic modeling blocks and memory modeling blocks. The former are programmable to perform logic functions, while the latter provide specific resources for modeling memories. Memories are used prevalently in modern circuit designs. It is thus more efficient to model (or emulate) them with dedicated resources containing random-access memory—memory modeling blocks—than with combinational and sequential components in logic modeling blocks.

A conventional emulation device, however, does not have dedicated modeling resources for content-addressable memories (CAMs). Unlike a conventional memory in which the user supplies a memory address and the memory returns the data word stored at that address, a content-addressable memory compares a search word supplied by the user against a table of stored data and returns one or more addresses where the search word is found. Content-addressable memories are used in a wide variety of applications requiring high search speeds. A notable example is classifying and forwarding internet protocol packets in network switches. Increasingly more circuit designs use content-addressable memories. Modeling content-addressable memories of thousands of lines deep and several hundred bits wide only with logic modeling blocks can be quite expensive. It would be preferable to take advantage of memory modeling blocks. However, significant challenges remain because the interface between memory modeling blocks and logic modeling blocks is quite limited for the matching operation of a content-addressable memory which needs access to all stored data within a short time period, e.g., a clock cycle.

### BRIEF SUMMARY OF THE INVENTION

Aspects of the invention relate to techniques for modeling content-addressable memory for emulation. An emulation device according to various embodiments of the invention comprises one or more memory modeling blocks reconfigurable to emulate a content-addressable memory or a random-access memory. The emulation device also comprises logic modeling blocks that are processor-based or FPGA-based.

Each of the one or more memory modeling blocks comprises memory circuitry and a dedicated comparison unit configured to compare a search word or a portion of a search word received by the each of the one or more memory modeling blocks with data stored in the memory circuitry. The comparison unit may comprise a comparator and a register coupled to the comparator and configured to store matching data. The comparison unit may further comprise an address counter coupled to the register and address port of the random-access memory circuitry. Matching data generated by the comparison unit may be unencoded matching data. The memory circuitry may be random-access memory circuitry.

A plurality of the memory modeling blocks may be programmable to emulate a single content-addressable memory. A single memory modeling block may be programmable to simultaneously emulate a content-addressable memory and a random-access memory.

An emulation process for a content-addressable memory according to various embodiments of the invention comprises loading a search word to one or more memory modeling blocks programmed to emulate the content-addressable memory, comparing the search word with data stored in the one or more memory modeling blocks by using a dedicated comparison unit in each of the one or more memory modeling blocks, and outputting matching data from the one or more memory modeling blocks.

The comparing operation may comprise reading one or more words from memory circuitry in the one or more memory modeling blocks according to address information provided by an address counter in each of the one or more memory modeling blocks and comparing the search word with each of the one or more words.

More than one memory modeling blocks may be configured to model the content-addressable memory based on its width and depth information. If so, matching data from each of these memory modeling blocks are combined into final matching data.

### BRIEF DESCRIPTION OF THE DRAWINGS

FIG. 1A shows an illustrative example of an emulation system; FIG. 1B shows an illustrative example of an emulation circuit board; and FIG. 1C shows an illustrative example of an emulation device.

FIG. 2 illustrates an example of a memory modeling block in an emulation device that has a dedicated comparison unit for content-addressable memory modeling according to various embodiments of the invention.

FIG. 3 illustrates a detailed block diagram of a memory modeling block having a dedicated comparison unit for content-addressable memory modeling according to some embodiments of the invention.

FIG. 4 illustrates a flow chart describing methods for using memory modeling blocks having dedicated comparison units to model a content-addressable memory that may be employed by various embodiments of the invention.

### DETAILED DESCRIPTION OF THE INVENTION

### General Considerations

Various aspects of the present invention relate to techniques for modeling content-addressable memory for emulation. In the following description, numerous details are set forth for the purpose of explanation. However, one of ordinary skill in the art will realize that the invention may be practiced without the use of these specific details. In other instances, well-known features have not been described in details to avoid obscuring the present invention.

Some of the techniques described herein can be implemented in software instructions stored on a computer-readable medium, software instructions executed on a computer, or some combination of both. Some of the disclosed techniques, for example, can be implemented as part of an electronic design automation (EDA) tool. Such methods can be executed on a single computer or on networked computers.

The detailed description of a method or a device sometimes uses terms like “compare,” and “emulate” to describe the disclosed method or the device function/structure. Such terms are high-level abstractions. The actual operations or functions/structures that correspond to these terms will vary depending on the particular implementation and are readily discernible by one of ordinary skill in the art.

Although the operations of the disclosed methods are described in a particular sequential order for convenient presentation, it should be understood that this manner of description encompasses rearrangements, unless a particular ordering is required by specific language set forth below. For example, operations described sequentially may in some cases be rearranged or performed concurrently. Moreover, for the sake of simplicity, the disclosed flow charts and block diagrams typically do not show the various ways in which particular methods can be used in conjunction with other methods.

### Illustrative Emulation System

FIG. 1A shows an illustrative example of an emulation system. As seen in this figure, the emulation system includes an emulator 120 coupled to a host workstation 110. The emulator 120 includes multiple printed circuit boards (emulation circuit boards) 130. These emulation circuit boards 130 are networked (not shown). A circuit design may be partitioned by the host workstation 110 and loaded to the emulation circuit boards 130 for emulation.

FIG. 1B illustrates an example of an emulation circuit board 130. The emulation circuit board 130 includes an array of emulation devices 140. The emulation devices 140 can be programmed to model, for example, combinatorial logic components, sequential circuit components and memories. The emulation devices 140 may be processor-based or FPGA-based.

Also included in the emulation circuit board 130 are an interconnect system 150, a programming system 160, and a debug system 170. The interconnect system 150 allows data to be moved between emulation devices 140. A portion of a circuit design on one emulation device may need data computed by another portion of the design on another emulation device. The programming system 160 enables a variety of other types of data to be brought in or out from an emulation device 140. Examples include programming data to configure an emulation device to perform a particular function, visibility data collected from the debug system 170 to be brought to the host workstation 110 for display, and content data either read from or written to memory circuitry in an emulation device 140. The debug system 170 enables the emulation system to monitor the behavior of a modeled circuit design. Needed data for visibility viewing purposes can be stored in the debug system 170. The debug system 170 may also provide resources for detecting specific conditions occurring in the circuit design. Such condition detection is sometimes referred to as triggering.

FIG. 1C illustrates an example of an emulation device 140. The emulation device 140 includes a plurality of logic modeling blocks 180 and a plurality of memory modeling blocks 190. The emulation device 140 may also include an interconnect system, a programming system, and a debug system, similar to the emulation circuit board 130. The logic modeling blocks 180 use FPGAs or Boolean processors to model general combinatorial logic such as AND, OR, XOR, inversion and more complex functions for multiple inputs. The logic modeling blocks 180 may also provide for the modeling of and/or include sequential components such as flip-flops and/or latches. The memory modeling blocks 190 provide specific resources for modeling memories in circuit designs. As noted before, memories are used prevalently in modern digital logic designs and although they could be modeled with the combinatorial and sequential components in the logic modeling blocks 180, they can be more efficiently modeled with specific dedicated resources typically containing random-access memory (RAM) blocks and an interface to connect the memory blocks to the logic modeling blocks 180.

It should be appreciated that the emulation system in FIG. 1A, the emulation circuit board 130, in FIG. 1B and the emulation device 140 in FIG. 1C are illustrated as examples only, and they are not intended to be limiting. Various embodiments of the invention may be implemented using only a subset of the components illustrated in the figures, or include an alternate combination of components, including components that are not shown in the figures.

### Dedicated Comparison Unit for CAM

FIG. 2 illustrates an example of a memory modeling block 190 having a dedicated comparison unit for content-addressable memory modeling according to various embodiments of the invention. As seen in the figure, a comparison unit 220 is coupled to memory circuitry 210 in the memory modeling block 190. As a result, data stored in the memory circuitry 210 can be read into the comparison unit 220 for comparison at a clock speed much faster than a typical clock speed between a memory modeling block 190 and a logic modeling block 180 (e.g., 300 MHz vs. 5 MHz). Moreover, the data path between the memory circuitry 210 and the comparison unit 220 is much wider than the output data path for the memory modeling block 190 (e.g., 128 bits vs. 32 bits). Both of these advantages associated with the dedicated comparison unit allow much more data to be accessed within a typical user clock cycle of an emulation model (in some cases a bit longer than the clock cycle between memory modeling blocks and logic modeling blocks) and thus improve the capacity of memory modeling blocks for modeling content-addressable memories.

The comparison unit 220 is also coupled to both an input interface 240 and an output interface 250. A search word, or a portion of a search word if a plurality of memory modeling blocks 190 are used to model a single content addressable memory, can be loaded to the comparison unit 220 through the input interface 240. The input interface 240 also serves a gateway for inputting data or address information to the memory circuitry 210. Similarly, the output interface 250 serves as a gateway for outputting both matching data from the comparison unit 220 and data read from the memory circuitry 210. The input interface 240 and the output interface 250 are controlled by a scheduler unit 230. The scheduler 230 receives instructions from a programming bus interface 260. The scheduler unit 230 and/or the programming bus interface 260 may also be coupled to the comparison unit 220 (not shown) to provide, for example, instruction data.

FIG. 3 illustrates a detailed block diagram of a memory modeling block 190 having a dedicated comparison unit 300 for content-addressable memory modeling according to some embodiments of the invention. The comparison unit 300 in this memory modeling block 190 includes a comparator 340 coupled with a register 350. The comparator 340 is configured to compare a search word with stored data while the register 350 is configured to store matching data. The comparison unit 220 also includes an address counter 380. The address counter 380 may receive a search starting address for the stored data to be searched and output an address that increments from the search starting address until the depth of the modeled content-addressable memory is covered. The depth of a content-addressable memory corresponds to the number of words stored in the content-addressable memory. These words have the same size as a search word.

The memory circuitry 330 includes two SRAMs (static random-access memories). Each SRAM may, for example, have a size of 32 k×39 bits (32 bits of data and 7 bits ECC for data integrity) and run at 200 MHz. The scheduler unit in this memory modeling block includes two independent schedulers 310 and 320, which may be referred to as sequencers as well. The schedulers 310 and 320, running at 100 MHz schedule access to the memory circuitry 330 and the comparison unit 300 by controlling multiplexers 373-379 and 391-397 in the input interface and the output interface, respectively. Each scheduled read data or matching data can be traced by using a trace data buffer 360. The memory modeling block 190 shown in FIG. 3 can be programmed to simultaneously emulate a content-addressable memory and a random-access memory, two content-addressable memories, or two random-access memories.

Modeling CAM with Memory Modeling Blocks

FIG. 4 illustrates a flow chart describing methods for using memory modeling blocks having dedicated comparison units to model a content-addressable memory that may be employed by various embodiments of the invention.

Initially, in operation 410, one or more memory modeling blocks are configured or programmed for emulating a specific content-addressable memory. Content-addressable memory words are written into memory circuitry in the one or more memory modeling blocks. Search word loading instruction and matching instruction are loaded into the one or more memory modeling blocks. The search word loading instruction may comprise input port information and comparison unit information for a search word and a search starting address. The matching instruction may comprise output port information and tracing mode information.

Depending on its size and depth, a content-addressable memory may be modeled by one memory modeling block or a plurality of memory modeling blocks. Long content-addressable memory words may be partitioned into several parts for storing in a corresponding number of memory modeling blocks. These memory modeling blocks will be programmed to work in parallel during matching operation. Matching results from these memory modeling blocks will be combined through an AND logic operation. Similarly, a large number of content-addressable memory words may be divided into several portions for storing in a corresponding number of memory modeling blocks. Matching results from these memory modeling blocks will be combined, however, through a concatenation operation. If the size of a content-addressable memory is small, the memory modeling block may be configured to store a plurality of words at each address. A pseudo search word comprising multiple search words may be compared with the same number of read words in one high speed memory circuitry clock cycle. This can increase the capacity of a memory modeling block to model a large content-addressable memory. Another approach to model a large content-addressable memory is to extend in time: using multiple user clock cycles for a match operation.

Some content-addressable memories work in a ternary mode: a search word or a stored word includes don't care bits each of which matches with either a “0” or a “1”. Some embodiments of the invention use a two-bit encoding method:

“01”=ternary code for 0;

“10”=ternary code for 1;

“11”=ternary code for “don't care”; and

“00”=ternary code for “never match”, matching only when compared to “don't care” (“11”).

The above is also summarized in table 1:

| | Pattern | | | |
|---|---|---|---|---|
| Key | 00 | 01 | 10 | 11 |
| 00 | 0 | 0 | 0 | 1 |
| 01 | 0 | 1 | 0 | 1 |
| 10 | 0 | 0 | 1 | 1 |
| 11 | 1 | 1 | 1 | 1 |

Next, in operation 420, a search word is loaded to the one or more memory modeling blocks. In the example shown in FIG. 2, the search word may be loaded through the input interface 240 to the comparison unit 220 based on the search word loading instruction.

Next, in operation 430, the loaded search word is compared with data stored in the one or more memory modeling blocks by using a dedicated comparison unit in each of the one or more memory modeling blocks. The comprising operation may comprise reading one or more words from memory circuitry in the one or more memory modeling blocks according to address information provided by an address counter in each of the one or more memory modeling blocks. The search word is compared with each of the one or more words. The matching result for each comparison may be stored in a register such as the register 350 in FIG. 3. The matching operation is to be completed in one user clock cycle (or more user clock cycles in some cases as discussed early).

Finally, in operation 440, matching data are outputted from the one or more memory modeling blocks. Two matching data formats are used by content-addressable memories: an encoded address indicating the address for a match and an unencoded output containing a BitVector of boolean values of which each bit is either true or false in accordance with the match status of a content-addressable address. With some implementations of the invention, unencoded matching data are outputted because the unencoded can be used to generate an encoded value whereas the converse is not true.

### CONCLUSION

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims. For example, while specific terminology has been employed above to refer to electronic design automation processes, it should be appreciated that various examples of the invention may be implemented using any desired combination of electronic design automation processes.

What is claimed is:

1. An emulation device, comprising:
one or more memory modeling blocks reconfigurable to emulate a content-addressable memory or a random-access memory, wherein each of the one or more memory modeling blocks comprises:
memory circuitry; and
a dedicated comparison unit configured to compare a search word or a portion of a search word received by the each of the one or more memory modeling blocks with data stored in the memory circuitry.

2. The emulation device recited in claim 1, wherein the comparison unit comprises:
a comparator; and
a register coupled to the comparator and configured to store matching data.

3. The emulation device recited in claim 2, wherein the comparison unit further comprises:
an address counter coupled to the register and address port of the random-access memory circuitry.

4. The emulation device recited in claim 1, wherein the memory circuitry is random-access memory circuitry.

5. The emulation device recited in claim 1, wherein a plurality of memory modeling blocks in the one or more memory modeling blocks are programmable to emulate a single content-addressable memory.

6. The emulation device recited in claim 1, wherein each of the one or more memory modeling blocks is programmable to simultaneously emulate a content-addressable memory and a random-access memory.

7. The emulation logic device recited in claim 1, wherein the dedicated comparison unit is further configured to generate unencoded matching data.

8. The emulation logic device recited in claim 1, further comprising one or more logic modeling blocks that are processor-based.

9. The emulation logic device recited in claim 1, further comprising one or more logic modeling blocks that are FPGA-based.

10. A method, comprising:
loading a search word to one or more memory modeling blocks programmed to emulate a specific content-addressable memory;
comparing the search word with data stored in the one or more memory modeling blocks by using a dedicated comparison unit in each of the one or more memory modeling blocks; and
outputting matching data from the one or more memory modeling blocks.

11. The method recited in claim 10, wherein the comparing comprises:
reading one or more words from memory circuitry in the one or more memory modeling blocks according to address information provided by an address counter in each of the one or more memory modeling blocks; and
comparing the search word with each of the one or more words.

12. The method recited in claim 10, wherein the outputting comprises:
outputting matching data from each of the one or more memory modeling blocks; and
combining the matching data from each of the one or more memory modeling blocks into final matching data.

13. The method recited in claim 10, wherein the matching data are unencoded.

14. The method recited in claim 10, wherein the method further comprises:
configuring the one or more memory modeling blocks for emulating the specific content-addressable memory based on width and depth information.
